(19) United States
(12) Patent Application Publication
(10) Pub. No.: US 2014/0281022 A1
(43) Pub. Date: Sep. 18, 2014

(54) DATA TRANSMISSION SCHEDULING

(71) Applicant: EMULEX DESIGN & MANUFACTURING CORPORATION, Costa Mesa, CA (US)

(72) Inventors: Sujith ARRAMREDDY, Saratoga, CA (US); Anthony HURSON, Austin, TX (US); Michael J. ENZ, Austin, TX (US); Daniel B. REENTS, Dripping Springs, TX (US); Randall L. FINDLEY, Austin, TX (US); Ashwin KAMATH, Cedar Park, TX (US)

(73) Assignee: Emulex Design & Manufacturing Corporation, Costa Mesa, CA (US)

(21) Appl. No.: 13/842,678

(22) Filed: Mar. 15, 2013

(51) Int. Cl. H04L 12/875

(52) U.S. Cl. CPC H04L 47/568
USPC 709/235

(57) ABSTRACT

A scheduler is disclosed. The scheduler can include a time-wheel structure configured to hold scheduling elements, an enqueuer configured to place a scheduling element on the time-wheel structure, and a delay manager configured to direct the scheduling element through the time-wheel structure and remove the scheduling element from the time-wheel structure. The time-wheel structure can include a plurality of decades that can rotate, and each of the plurality of decades can rotate respectively at one or more different rates of rotation. Multiple scheduling elements can be on the time-wheel structure at least partially during the same time. The scheduling elements can be on different decades or on the same decade. One of the plurality of decades can comprise an entry configured to hold a plurality of scheduling elements.

### FIELD OF THE DISCLOSURE

This relates generally to data communications, and more specifically to the scheduling of data transmissions with a wide range of data transfer rates, a fine-grained control over the granularity of the data transfer rates, and a high number of data flows, or any combination of the three.

### BACKGROUND OF THE DISCLOSURE

Controlling the flow of communication traffic in networking can be an important aspect of proper network operation. Traffic control can help, for example, to reduce congestion throughout a network, including at networking endpoints and at intermediate nodes within the network.

In today's networks, the requirements for traffic control can be demanding. For example, the Institute of Electrical and Electronics Engineers (IEEE) Quantized Congestion Notification (QCN) standard requires dynamic congestion control for individual flows in a network, with the ability to support a wide range of data transmission rates while maintaining fine-grained control over the granularity of those data rates. Moreover, such individual flow traffic control may need to be performed for flows numbering in the low thousands, or higher.

Many of today's network traffic control schemes cannot meet all or some of the requirements like those of the QCN standard.

### SUMMARY OF THE DISCLOSURE

This relates to a scheduler. The scheduler can include a time-wheel structure that includes a plurality of decades, where each decade can rotate. Further, the time-wheel structure can hold scheduling elements. The scheduler can include an enqueuer that can place a first scheduling element on the time-wheel structure, and a delay manager that can direct the first scheduling element through the time-wheel structure and remove the first scheduling element from the time-wheel structure. The scheduler can be used, for example, for scheduling data transmissions in a network. For instance, the first scheduling element can correspond to a scheduled transmission of data from a transmitter. After sufficient time has passed such that the first scheduling element has progressed through the time-wheel structure and has been removed from the time-wheel structure by the delay manager, the transmitter can initiate the scheduled transmission of data.

In some examples, each of the plurality of decades can rotate at one or more different rates of rotation. In this way, the time-wheel structure can support a wide range of data transmission rates while maintaining fine-grained granularity of those rates.

In some examples, the enqueuer can place the first scheduling element on a first decade of the plurality of decades and a second scheduling element on a second decade of the plurality of decades, where the first scheduling element and the second scheduling element can be on the time-wheel structure at least partially during the same time. This is one way that the scheduler can support a wide range of data transmission rates. For instance, the first and second scheduling elements can be respectively associated with first and second data flows. When placed on different decades, the first and second scheduling elements can move through the time-wheel structure in significantly different amounts of time. These different amounts of time can correlate to different data transmission rates for the first and second data flows, even a wide range of transmission rates.

In some examples, the enqueuer can place a second scheduling element on the time-wheel structure, where the first scheduling element and the second scheduling element can be on the same decade of the plurality of decades at least partially during the same time. This is one way that the scheduler can facilitate fine-grained granularity of data transmission rates. For example, the first and second scheduling elements can be located close to each other on the same decade such that the scheduler can facilitate the transmission of data by data flows corresponding to the first and second scheduling elements at substantially similar times.

In some examples, one of the plurality of decades can include an entry that can hold a plurality of scheduling elements. In this way, the scheduler can accommodate the data transmission rates of a large number of flows.

In some examples, the enqueuer can place the first scheduling element on the time-wheel structure based on a first delay value, which can correspond to a transmission rate of a first data flow. In some examples, the delay manager can direct the first scheduling element through the time-wheel structure based on at least a portion of a first delay value. In some examples, the first scheduling element can store at least a portion of a first delay value. In some examples, an integrated circuit can incorporate the scheduler. In some examples, a network adapter can incorporate the integrated circuit. In some examples, a server can incorporate the network adapter. In some examples, a network can incorporate the server.

### BRIEF DESCRIPTION OF THE DRAWINGS

FIG. 1 illustrates an exemplary network in which some of the examples of this disclosure may be practiced.

FIG. 2A is a block diagram that illustrates one way of individually controlling the data transmission rates of multiple data flows originating from a single endpoint node.

FIG. 2B illustrates a table that reflects the scheduling logic's activity over twelve time units of operation, in accordance with the example given above.

FIG. 3 illustrates an exemplary scheduler with a “time-wheel” structure that can handle high flow-count, wide data range, fine-grained granularity scheduling of data transmissions.

FIG. 4 illustrates in further detail the exemplary structure and operation of the “time-wheel” structure of an example scheduler.

FIG. 5A illustrates an exemplary data structure for implementing each decade of the time-wheel structure of this disclosure.

FIG. 5B illustrates an exemplary data structure for a linked list element as it may exist in the time-wheel structure of this disclosure.

FIG. 5C illustrates an exemplary representation of a delay value, whether phase-adjusted or not, in accordance with the examples disclosed.

FIG. 6 illustrates an exemplary device that can implement the examples of this disclosure.

### DETAILED DESCRIPTION

In the following description of examples, reference is made to the accompanying drawings which form a part hereof, and in which it is shown by way of illustration specific examples that can be practiced. It is to be understood that other examples can be used and structure changes can be made without departing from the scope of the disclosed examples. Further, while the following description of examples is provided with reference to data transmission scheduling in a network, the scope of this disclosure can extend to data transmission scheduling in different environments, for example in a data bus.

Controlling the flow of communication traffic in networking can be an important aspect of proper network operation. Traffic control can help, for example, to reduce congestion throughout a network, including at networking endpoints and at intermediate nodes within the network. In today's networks, traffic control schemes may be required to possess the ability to support a wide range of data transmission rates while maintaining fine-grained control over the granularity of those data rates. Moreover, such traffic control may need to be performed individually for network data flows numbering in the low thousands, or higher.

FIG. 1 illustrates an exemplary network 100 in which some of the examples of this disclosure may be practiced. The network 100 can include various intermediate nodes 102. These intermediate nodes 102 can be devices such as switches or hubs, or other devices. The network 100 can also include various endpoint nodes 104. These endpoint nodes 104 can be devices such as computers, mobile devices, servers, storage devices, or other devices. The intermediate nodes 102 can be connected to other intermediate nodes and endpoint nodes 104 by way of various network connections 106. These network connections 106 can be, for example, Ethernet-based, Fibre Channel-based, or can be based on any other type of communication protocol.

The endpoint nodes 104 in the network 100 can transmit data to each other through network connections 106 and intermediate nodes 102. However, network congestion can result under certain circumstances. For example, when multiple source endpoint nodes 104 simultaneously transmit large amounts of data to the same destination endpoint node at another location in the network 100, the network connection 106 connected to the destination endpoint node, as well as the intermediate node 102 in front of the destination endpoint node, can be tasked with carrying data at rates higher than the network connection or the intermediate node can handle. This, in turn, can result in the data buffers of the intermediate node 102 filling rapidly and causing network congestion.

One scheme for controlling network congestion can be to control the rates at which the various endpoint nodes 104 transmit data into and through the network 100. Because the various endpoint nodes 104 can be of different types, and therefore can have different data transmission rate capabilities or requirements, or both, the data transmission rates of the various endpoint nodes may be controlled individually. Moreover, each endpoint node 104 can be transmitting one or more data flows simultaneously; the data transmission rates of these multiple data flows can also be controlled individually. In some examples, the endpoint nodes 104 can adjust their data transmission rates in response to control messages received from intermediate nodes 102, the control messages being sent in response to network congestion sensed by the intermediate nodes.

Although the examples of this disclosure focus on controlling data transmissions originating from an endpoint node 104 in a network 100, the scope of this disclosure also extends to controlling data transmissions in the middle of a network, such as at an intermediate node 102. Further, the teachings of data transmission scheduling described below need not be implemented only in response to network congestion. Rather, such scheduling can be utilized in normal network operation to control data transmission rates in a network.

FIG. 2A is a block diagram that illustrates one way of individually controlling the data transmission rates of multiple data flows originating from a single endpoint node 200. The endpoint node 200 can include a transmitter 202 that can transmit multiple flows of data through a network connection 212 into a network. The transmitter 202 can include scheduling logic 204. In this example, the transmitter 202 can be transmitting three flows of data: flow A 206, flow B 208 and flow C 210. Each flow can have a specified amount of data to transmit into the network. It is understood that three flows are provided by way of example only; any number of flows can be controlled.

Each flow can be configured to send a quantum of its own data when it receives a “send data” signal from the scheduling logic 204. The size of each quantum of data sent can be constant within a single flow, and from flow to flow. In this way, the more frequently the scheduling logic 204 sends a “send data” signal to a given flow, the higher that flow's data transmission rate can be into the network. Further, the size of each quantum sent by each flow can be kept small so as to prevent any single flow from monopolizing network resources during a transmission, though this need not be the case. It is understood, however, that the size of each quantum need not be constant within a single flow, and from flow to flow, for the operation of this data transmission rate control scheme. Further, a quantum of data can be defined in various ways. For example, a quantum of data can be a single packet of data, each packet having a specified size, or it can be multiple packets of data. For ease of understanding, the examples of this disclosure will be described in terms of transmissions of single packets of data; however the scope of this disclosure extends to transmissions of various quanta of data as well.

For example, flow A 206, flow B 208 and flow C 210 can have different target data transmission rates. Flow A's 206 target data transmission rate can be one packet per time unit, flow B's 208 target data transmission rate can be one-half packet per time unit, and flow C's 210 target data transmission rate can be one-quarter packet per time unit. A time unit can correspond to any number of clock cycles, integer or non-integer, of a processor of the scheduling logic 204 that implements the data transmission scheduling. For ease of understanding, data transmission rates in this disclosure will be described in terms of time units.

In order to achieve these individual data rates for each flow, scheduling logic 204 can be configured to send a “send data” signal to each flow at individual delay times; in this case, to flow A 206 once every time unit, to flow B 208 once every two time units, and to flow C 210 once every four time units. Upon receiving their respective “send data” signals, flow A 206, flow B 208 and flow C 210 can in turn transmit their respective packets of data into the network through the network connection 212. In this way, flow A 206 can have an effective data transmission rate of one packet per time unit, flow B 208 can have an effective data transmission rate of one-half packet per time unit, and flow C 210 can have an effective data transmission rate of one-quarter packet per time unit, in line with the target data transmission rates provided above. Thus, each flow can operate at its own individualized data transmission rate. It is understood that the rate at which the scheduling logic 204 sends “send data” signals to individual flows, and thus the data transmission rates of the individual flows, need not be constant, but rather can change with time.

FIG. 2B illustrates a table 214 that reflects the scheduling logic's 204 activity over twelve time units of operation, in accordance with the example given above. The left-most column of table 214 lists flow A 206, flow B 208 and flow C 210. The upper-most row lists the time units of interest; in this case, time units 1 through 12. Each “x” in table 214 corresponds to a “send data” signal sent from the scheduling logic 204 to a flow corresponding to the flow of that row, and at a time unit corresponding to the time unit of that column. For example, “x” 216 signifies that the scheduling logic 204 sent a “send data” signal to flow B 208 at time unit 2.

Accurately and efficiently handling a transmission schedule such as the one described above for thousands of flows while supporting a wide range of data transmission rates with fine-grained granularity can be challenging. For example, supporting data transmission rates from 10 Mbps to 10 Gbps, while having the ability to individually control data rates in steps of 10 Mbps for thousands of flows can be desired. At such levels of operation, the scheduling logic in a transmitter can expend a significant portion of its processing power on such scheduling work, and can therefore possibly miss scheduling times. For example, one could maintain a single memory with entries corresponding to each of thousands of flows in a network. Each entry could contain the next time that the flow corresponding to that entry is allowed to transmit data. The scheduling logic's processor could navigate through such a memory, entry by entry, and determine if the time for transmission for the flow corresponding to the current entry has arrived. This, however, can cause missed scheduling prompts, because the time for transmission for a flow entry located thousands of entries away in the memory can expire before the processor is able to reach that entry for processing. Missing scheduling prompts in this way can lead to inaccurate data transmission rates.

FIG. 3 illustrates an exemplary scheduler 314 with a “time-wheel” structure that can handle high flow-count, wide data range, fine-grained granularity scheduling of data transmissions. A data flow transmission request can be initiated by host 301. The request can be associated with a specific amount of data to be transmitted, for example one megabyte of data. The request can be processed by a request processor 302, which can determine the amount of delay required for the requested flow based on the flow's target data transmission rate. A phase adjuster 303 can then adjust the delay calculated by the request processor 302, if needed. The operation of the phase adjuster 303 will be described later. An enqueuer 304 can place a scheduling element (“element”) 305 representing the requested data flow transmission in a time-wheel structure 310. The element 305 can be placed in the time-wheel structure 310 with the delay calculated by the request processor 302, and adjusted by the phase adjuster 303, such that at the expiration of the adjusted delay, the flow represented by the element can be prompted to send a packet of its data into a network, as described above. Also as described above, the packet of data can be configured to be a constant size within the flow, or from flow to flow, though it need not be a constant size.

The delay manager 306 can direct the progression of the element 305 through the time-wheel structure 310, the specifics of which will be described later. When the delay associated with the element 305 has expired, in which case the element 305 has made its way to the end of the time-wheel structure 310, the delay manager 306 can place the element in an immediate service queue (ISQ) 312. Once placed in an ISQ 312, a dequeuer 308 can remove the element 305 from the ISQ, and can send the element to the transmit logic 316.

The transmit logic 316 can then cause the flow associated with the element 305 to transmit a packet of its data into the network. As stated above, the flow associated with the element 305 need not be limited to transmitting a single packet of its data at a time; rather, it could transmit some quantum of data, the quantum of data being a collection of packets, a specified amount of data, or any other definition of a quantum of data.

If data still remains to be transmitted for the flow associated with the element 305, the transmit logic 316 can send the element back to the enqueuer 304, by way of the phase adjuster 303, for repeated placement in the time-wheel structure 310 for further scheduling of a data transmission. For example, in the case of a host 301 initially requesting to send a one megabyte data flow into the network, and each packet of data being configured to be a constant eight kilobytes in size, 128 packets of data must be sent to transmit the entire one megabyte of data. If the flow associated with the element 305 has only transmitted 100 data packets thus far, the transmit logic 316 can send the element back to the enqueuer 304, by way of the phase adjuster 303, for scheduling the data transmission of the next of the remaining 28 data packets. The enqueuer 304 can re-insert the element 305 into the time-wheel structure 310 with the appropriate delay value based on the desired transmit rate of the data flow associated with the element. It is understood that the desired transmit rate of the data flow associated with the element 305 need not remain constant from one transmission to the next, but rather can be variable. Further, although the operation of the scheduler 314 has been described with reference to a single element 305, it is understood that the operations described above can be performed sequentially with multiple elements, such that multiple elements can be on the time-wheel structure 310 simultaneously.

Alternatively to the operations described above, when a data flow transmission request is initiated by host 301, the request processor 302 can process the request, and the enqueuer 304 can immediately place an element 305 representing the requested data flow transmission in an ISQ 312. From this point forward, the operation of the scheduler 314 and the transmit logic 316 can be as described above.

The scheduler 314 can be implemented by a combination of circuits, memories, or processors. The phase adjuster 303, the enqueuer 304, the delay manager 306, and the dequeuer 308 can comprise one or more circuits, or can be implemented by processors, whether general purpose or specialized. The “time-wheel” structure 310 can comprise memory, such as read/write memory or RAM. The association of an element 305 with the data flow represented by the element can be reflected in the index of the element in the time-wheel structure memory. For example, the index of the element in the memory can be equivalent to the flow identification number of the data flow represented by the element.

FIG. 4 illustrates in further detail the exemplary structure and operation of the “time-wheel” structure 310 of an example scheduler. The time-wheel structure 310 can comprise five decades: decade 0 404, decade 1 406, decade 2 408, decade 3 410 and decade 4 412. Each decade can comprise sixteen entries. Each decade can operate as its own “time-wheel,” and each decade can “rotate” or expire at successively higher binary power-of-two multiples. For example, decade 0 can rotate once every 1)(2° time unit, decade 1 can rotate once every 16 (2⁴) time units, decade 2 can rotate once every 256 (2⁸) time units, decade 3 can rotate once every 4,096 (2¹²) time units, and decade 4 can rotate once every 65,536 (2¹⁶) time units. More specifically, an element located at decade 0, row 3, can move to decade 0, row 2 after 1 time unit because of the rotation rate of decade 0. At the expiration of the next time unit, that same element can move to decade 0, row 1. In contrast, an element located at decade 2, row 3, can move to decade 2, row 2, after 256 time units because of the rotation rate of decade 2. It is understood that a time-wheel structure with five decades is disclosed by way of example only. The operation of the examples of this disclosure is possible with time-wheel structures containing fewer or more decades. Further, the frequencies of rotation of the decades need not be successively higher binary power-of-two multiples, and each decade need not contain sixteen entries; the frequencies of rotation of the decades could, for example, be multiples of ten, and fewer or more than sixteen entries per decade can be implemented. The rotation of each decade of the time-wheel structure can be performed by a processor with reference to a timing reference 422, the timing reference being provided by a processor or timing circuit in the scheduler 314, or being provided by a processor or timing circuit that is external to the scheduler.

As an element in a decade reaches row 0 in that decade, the element can either be placed in an appropriate entry in a lower decade, or it can be placed in an ISQ 312 for data transmission. When an element reaches row 0 in a decade other than decade 0, the delay manager 306 can determine whether the element has any delay remaining to expend. If the element has no delay remaining to expend, the delay manager 306 can place the element in an ISQ 312. If the element does have delay remaining to expend, it can be placed in the next lowest decade and row in accordance with the element's remaining delay. This can be accomplished by the delay manager 306 placing the element in a lower decade and row position that provides for the largest amount of delay, without exceeding the element's remaining delay to expend. The delay that will remain after the element reaches row 0 in the lower decade, if any, can be used in the next decade placement operation performed by the delay manager 306.

Entries that reach row 0 in decade 0 can be placed in an ISQ 312 by the delay manager 306.

For example, an element 305 can have an initial delay value 401 of 5000 time units. The enqueuer 304 can place the element 305 in decade 3, row 1, because that position provides for the highest delay value (4,096 time units) without exceeding 5,000 time units. With this placement, the remaining delay (the delay remaining for the element 305 to expend after it reaches row 0 of its current decade) for the element can be 904 time units. Assuming the element 305 is placed in decade 3, row 1, immediately after decade 3 has rotated, the element can wait at decade 3, row 1, for 4,096 time units. At that time, decade 3 can rotate, and element 305 can be positioned at decade 3, row 0. Then, the element 305 would need to be re-positioned into another decade to expend its remaining delay time. In this example, the delay manager 306 can place the element 305 in decade 2, row 3, to expend 768 time units. As described above, this placement provides the largest amount of delay without exceeding 904 time units, the element's 305 remaining delay. With this placement, the remaining delay for the element 305 can be 136 time units. The element 305 can then remain in decade 2 for three rotations, each rotation occurring after 256 time units. After reaching row 0 of decade 2 in this way, the delay manager 306 can place the element 305 in decade 1, row 8, to expend 128 time units. With this placement, the remaining delay for the element 305 can be 8 time units. The element 305 can remain in decade 1 for eight rotations, each rotation occurring after 16 time units, until the element reaches row 0 of decade 1. At this point, for its final positioning in a decade, the delay manager 306 can place the element 305 in row 8 of decade 0, to expend its final 8 time units. The element 305 can remain in decade 0 for 8 rotations, each rotation occurring after 1 time unit, until the element reaches row 0 of decade 0. At this point, the delay manager 306 can place the element 305 in an ISQ 312.

The operation of the phase adjuster 303, as illustrated in FIG. 3, will now be described. Before an element 305 is enqueued onto the time-wheel structure by the enqueuer 304, it can be necessary to adjust the delay time of the element to account for time that may have already transpired since the last rotation of the decade onto which the element is being enqueued. Otherwise, large discrepancies between the desired delays and the actual delays for the element 305 can result. For example, an element 305 to be enqueued onto row 1 of decade 4 can be intended to reside in row 1 of decade 4 for 65,536 time units, at which time decade 4 can rotate once, and the element can then be located at row 0 of decade 4. However, it can be the case that right before the enqueueing of the element 305 onto row 1 of decade 4, 65,535 time units have transpired since decade 4 last rotated. In this scenario, the element 305 would be enqueued onto row 1 of decade 4 1 time unit before decade 4 is set to rotate. This can result in an unwanted loss of delay of 65,535 time units.

To deal with this scenario, the phase adjuster 303 can determine a phase adjustment time, for example, by tracking the time that has transpired since each decade's last rotation. Before an element 305 is to be enqueued by the enqueuer 304, the phase adjuster 303 can add a phase adjustment time to the element's original delay value. The phase adjustment time may be the amount of time since the particular decade onto which the element 305 is to be enqueued last rotated. The enqueuer 304 can then enqueue the element 305 based on the adjusted delay value, and not the original delay value. In this way, errors of the kind described here can be avoided. The phase adjustment time can ensure that the desired delay for the element 305 matches the actual delay for the element.

Although the preceding example is described with delay values having relative time units, it is understood that absolute time units can be used instead in accordance with the examples of this disclosure. For example, the delay value 401 of an element 305 can be expressed as the absolute time at which the delay for the element should expire, and not the relative time at which the delay for the element should expire. Appropriate modifications to the scheduler 314 can be made to accommodate such an implementation, including eliminating the phase adjuster 303 and adding functionality for reading the current absolute time.

By utilizing the time-wheel structure of this disclosure, a wide range of data transmission rates can be supported, while maintaining fine-grained control of the granularity of the transmission rates, for data flows numbering in the thousands or higher. In the example disclosed above, data rates as high as 1 packet per time unit, and as low as 1 packet per 2²⁰ time units (corresponding to an element being placed in the highest-numbered row of each decade as it moves through the time-wheel structure) can be supported—a wide range of rates. Further, because decade 0 can rotate every time unit, data rates having variations of 1 packet per time unit can be scheduled—fine-grained control of the granularity of rates. In the case of a packet size of 8 KB (or 64 Kb), a 400 MHz scheduling processor clock, and a time unit equal to 32 clock cycles, this can translate to a data transmission rate range of approximately 10 Mbps to 10 Gbps, with control granularity of 10 Mbps. Elements with large delay values can move slowly in the slowly-rotating decades while elements with short delay values can be processed rapidly in the faster-rotating decades. The elements that the scheduler needs to process most frequently can be located in the lowest decade.

FIG. 5A illustrates an exemplary data structure for implementing each decade of the time-wheel structure of this disclosure. Each decade can comprise a rotating array 500 of linked lists 502. Each linked list element 305 can represent an individual flow. By utilizing linked lists 502 in each entry of the rotating array 500, multiple linked list elements 305 can share the same entry of the rotating array, and can therefore have the same delay values in the decade implemented by the rotating array. For each rotating array 500, there can be a memory pointer 506 that points to the location in the array that can be the current row 0 of the decade represented by the rotating array. In this example, location 11 in the rotating array 500 can be the current row 0 of the decade. Thus, new linked list elements 305 can be added to the decade at a location in the array relative to the memory pointer 506 representing row 0. In this example, if a new linked list element 305 is to be added to row 2 of the decade, it can be added at location 13 because memory pointer 506 signifies that location 11 is the current row 0 of the decade. If the relative location in the rotating array 500 to which a new linked list element 305 is to be added overflows off of location 15, or the end, of the rotating array, the location determination can continue by wrapping back around to location 0, or the top, of the rotating array.

The “rotation” of the rotating array 500, which represents a decade, can be accomplished by moving the memory pointer 506 from its current array location to the next higher-numbered array location. In this example, memory pointer 506 can move from pointing to location 11 to pointing to location 12 when the rotating array 500 rotates. When the memory pointer 506 reaches the end of the rotating array 500 (here, location 15), it can wrap back around to the top of the rotating array (here, location 0) during the rotating array's next rotation. When a linked list element 305 is added to a location in the rotating array, it can be added to the linked list 502 already in existence at that array location, if one exists. Otherwise, the linked list element 305 can become the first element of a new linked list at that location in the rotating array 500. By utilizing linked lists 502 in the rotating array 500, large numbers of data flows can be supported because new linked list elements 305 corresponding to data flows can be easily added to various positions in the rotating array. It is understood that the rotating arrays 500 of this disclosure need not be physically organized as such in memory, but rather can be logical arrays represented by registers and pointers that map the logical constructs of the arrays to their corresponding physical locations in memory.

FIG. 5B illustrates an exemplary data structure for a linked list element 305 as it may exist in the time-wheel structure of this disclosure. Each linked list element 305 in the rotating array 500 structure of this disclosure can be represented by a 27-bit value, regardless of where in the time-wheel structure the linked list element is placed. Bits 16-26 can contain the pointer to the next linked list element 305 in the linked list. If the linked list element 305 is the only linked list element in the linked list, the pointer to the next linked list element can be empty or null, or can point back to the linked list element itself. If the linked list element 305 is the last linked list element in the linked list, the pointer to the next linked list element can be empty or null, or can point back to the first linked list element in the linked list. Using the data structure of this example, each linked list can contain 2¹¹ linked list elements 305 because the 11 binary digits used as the pointer to the next linked list element can resolve to 2¹¹ unique memory addresses.

Bits 0-15 can represent the linked list element's 305 delay to expend in decades 0-3. The linked list element 305 need not store its delay to expend in decade 4, if any, because that delay can already be accounted for by its row placement in decade 4. Specifically, bits 12-15 can represent the delay to be expended in decade 3, if any, bits 8-11 can represent the delay to be expended in decade 2, if any, bits 4-7 can represent the delay to be expended in decade 1, if any, and bits 0-3 can represent the delay to be expended in decade 0, if any. The collection of these linked list elements can reside, for example, in a memory as provided for the time-wheel structure 310 in FIG. 3.

FIG. 5C illustrates an exemplary representation of a delay value 401, whether phase-adjusted or not, in accordance with the examples disclosed. The delay value 401 can be a 20-bit binary, or a 5-digit hexadecimal, value. Bits 19-16, or the most significant hexadecimal digit, can represent the row number in decade 4 into which the element that is associated with the delay value 401 can be placed. Bits 12-15, or the second-most significant hexadecimal digit, can represent the row number in decade 3 into which the element that is associated with the delay value 401 can be placed. This representation can continue through to bits 0-3, or the least significant hexadecimal digit, which can represent the row number in decade 0 into which the element associated with the delay value 401 can be placed. Such a representation can work well with the time-wheel structure of this disclosure because each hexadecimal digit of the delay value 401 can resolve to 16 values (a 4-digit binary number), and each decade in the time-wheel structure of this disclosure can contain 16 row entries. However, it is understood that the time-wheel structure of this disclosure need not contain 16 row entries per decade. Nor must the time-wheel structure contain five decades. Such a delay value representation is provided by way of example only, and does not limit the scope of this disclosure. These delay values 401 can be stored, for example, in a memory where each individual flow can have its delay value stored. This memory can reside in the scheduler 314, or can be external to the scheduler. Bits 0-15 of the delay value 401 can also be stored in element 305, as in FIG. 5B.

FIG. 6 illustrates an exemplary device 600 that can implement the examples of this disclosure. The device 600 can include logic 606, such as one or more processors or circuits, a memory 608, and a host interface 604. The components of the device 600 can all be connected to one or more busses 610, and can be adapted to communicate with each other using the one or more busses. The logic 606 can execute instructions embodied in transmission media (e.g. propagation signals, transmission signals, etc.) or in computer-readable storage media such as the memory 608. A host 602 can communicate with the device 600 via the host interface 604. Alternatively, the device 600 can reside in a host, and the host 602 can comprise a host processor. The logic 606 and the memory 608 can, for example, implement the request processor 302, the scheduler 314 and the transmit logic 316 of FIG. 3. The host interface 604 can, for example, provide for the communication between the host 301 and the request processor 302 of FIG. 3.

Although examples of this disclosure have been fully described with reference to the accompanying drawings, it is to be noted that various changes and modifications will become apparent to those skilled in the art. Such changes and modifications are to be understood as being included within the scope of examples of this disclosure as defined by the appended claims.

1. A scheduler comprising:
a time-wheel structure configured to hold one or more scheduling elements, the time-wheel structure comprising a plurality of decades, each decade configured to rotate;
an enqueuer configured to place a first scheduling element on the time-wheel structure; and
a delay manager configured to direct the first scheduling element through the time-wheel structure and remove the first scheduling element from the time-wheel structure.

2. The scheduler of claim 1, wherein each of the plurality of decades are configured to rotate respectively at one or more different rates of rotation.

3. The scheduler of claim 2, wherein the enqueuer is configured to place the first scheduling element on a first decade of the plurality of decades and a second scheduling element on a second decade of the plurality of decades, the first scheduling element and the second scheduling element being on the time-wheel structure at least partially during the same time.

4. The scheduler of claim 2, wherein:
the enqueuer is configured to place a second scheduling element on the time-wheel structure, and
the first scheduling element and the second scheduling element are on the same decade of the plurality of decades at least partially during the same time.

5. The scheduler of claim 1, wherein one of the plurality of decades comprises an entry configured to hold a plurality of scheduling elements.

6. The scheduler of claim 1, wherein the enqueuer is configured to place the first scheduling element on the time-wheel structure based on a first delay value, the first delay value corresponding to a transmission rate of a first data flow.

7. The scheduler of claim 1, wherein the delay manager is configured to direct the first scheduling element through the time-wheel structure based on at least a portion of a first delay value.

8. The scheduler of claim 1, wherein the first scheduling element stores at least a portion of a first delay value.

9. An integrated circuit incorporating the scheduler of claim 1.

10. A network adapter incorporating the integrated circuit of claim 9.

11. A server incorporating the network adapter of claim 10.

12. A network incorporating the server of claim 11.

13. A method for scheduling performed by a scheduling device comprising a time-wheel structure, the method comprising:
placing a first scheduling element on the time-wheel structure, the time-wheel structure comprising a plurality of decades, each decade configured to rotate;
directing the first scheduling element through the time-wheel structure; and
removing the first scheduling element from the time-wheel structure.

14. The method of claim 13, wherein each of the plurality of decades are configured to rotate respectively at one or more different rates of rotation.

15. The method of claim 14, wherein placing the first scheduling element on the time-wheel structure comprises placing the first scheduling element on a first decade of the plurality of decades, the method further comprising:
placing a second scheduling element on a second decade of the plurality of decades, the first scheduling element and the second scheduling element being on the time-wheel structure at least partially during the same time.

16. The method of claim 14, the method further comprising placing a second scheduling element on the time-wheel structure, the first scheduling element and the second scheduling element being on the same decade of the plurality of decades at least partially during the same time.

17. The method of claim 13, wherein one of the plurality of decades comprises an entry configured to hold a plurality of scheduling elements.

18. A machine-readable storage medium for a scheduling device comprising a time-wheel structure, an enqueuer, and a delay manager, the machine-readable storage medium storing instructions that, when executed by one or more processors, cause the scheduling device to perform a method comprising:
placing a first scheduling element on the time-wheel structure, the time-wheel structure comprising a plurality of decades, each decade configured to rotate;
directing the first scheduling element through the time-wheel structure; and
removing the first scheduling element from the time-wheel structure.

19. The machine-readable storage medium of claim 18, wherein each of the plurality of decades are configured to rotate respectively at one or more different rates of rotation.

20. The machine-readable storage medium of claim 19, wherein placing the first scheduling element on the time-wheel structure comprises placing the first scheduling element on a first decade of the plurality of decades, the method further comprising:
placing a second scheduling element on a second decade of the plurality of decades, the first scheduling element and the second scheduling element being on the time-wheel structure at least partially during the same time.

21. The machine-readable storage medium of claim 19, the method further comprising placing a second scheduling element on the time-wheel structure, the first scheduling element and the second scheduling element being on the same decade of the plurality of decades at least partially during the same time.

22. The machine-readable storage medium of claim 18, wherein one of the plurality of decades comprises an entry configured to hold a plurality of scheduling elements.
